(19) United States
(12) Patent Application Publication
(10) Pub. No.: US 2025/0298986 A1
(43) Pub. Date: Sep. 25, 2025

(54) HETEROGENEOUS ANALYSIS OF COMMUNICATION RECORDS USING LARGE LANGUAGE MODELS

(71) Applicant: Zoom Video Communications, Inc., San Jose, CA (US)

(72) Inventors: Davide Giovanardi, San Jose, CA (US); Bilung Lee, Irvine, CA (US); Chih-Kai Ting, Milpitas, CA (US)

(73) Assignee: Zoom Video Communications, Inc., San Jose, CA (US)

(21) Appl. No.: 18/610,914

(22) Filed: Mar. 20, 2024

(51) Int. Cl. G06F 40/35; G06F 40/40

(52) U.S. Cl. CPC G06F 40/35; G06F 40/40

(57) ABSTRACT

One example method includes receiving a request to generate an analysis of communication records, the communication records associated with a plurality of types of communication records; accessing a plurality of communication records associated with the request, each communication record of the plurality of communication records corresponding to one type of the plurality of types of communication records; for the communication records of a respective type of communication records, generating, using a trained large language model (“LLM”), one or more analyses of the respective communication records; for each type of communication record, generating, using the trained LLM, a homogeneous analysis of the one or more analyses of the respective communication records corresponding to the respective type of communication records; generating, using the trained LLM, a heterogeneous analysis of the homogeneous analyses of the types of communication records; and providing the heterogeneous analysis in response to the request.

### FIELD

The present application generally relates to large language models (“LLMs”), and more particularly relates to heterogeneous analysis of communication records using LLMs.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for heterogeneous analysis of communication records using LLMs;

FIGS. 3A-3B show an example system for heterogeneous analysis of communication records using LLMs;

FIGS. 4-5 show example graphical user interfaces for heterogeneous analysis of communication records using LLMs;

FIG. 6 shows an example method for heterogeneous analysis of communication records using LLMs; and

FIG. 7 shows an example computing device suitable for use with example systems and methods for heterogeneous analysis of communication records using LLMs.

### DETAILED DESCRIPTION

Examples are described herein in the context of heterogeneous analysis of communication records using large language models. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

In modern life, people frequently interact using electronic devices, such as by chat messaging, one-on-one phone calls, or virtual conferences, such as video or telephone conferences. In many cases, such communication channels may be hosted by a virtual conference provider, even in the case of one-on-one phone calls or chat messages. Virtual conference providers may provide enhancements of some of these channels by providing transcripts of a conversation or a conference, either in real-time or after the conclusion of the conference. Real-time transcripts can assist participants who may have difficulty hearing or who do not speak the language(s) used by other participants in the conference. Transcripts can also be used after a conference to review the details of the discussion, which may provide action items or important information to guide work on a project. In some cases, participants may use transcripts of past conferences, chat logs, email chains, or other communications to prepare for an upcoming conference, such as to recall information discussed during the meeting.

For example, over the course of several weeks, a person may attend multiple meetings, missed one or two other meetings, and engaged in a variety of chat discussions and email chains with colleagues. Given the volume of communications and the person's attention to other aspects of their job, they may have difficulty remembering the content of the various discussions across multiple different communication channels. To assist the person with recalling these discussions, they may employ an artificial intelligence (“AI”)-based assistant and enable it to access the prior discussions and to generate a condensed representation of those discusses for the user to review. The representation may be a summary, bullet points, or important topics raised in the relevant portions of the discussion.

To use the AI assistant, the user can provide a query targeting one or more communication records. The query may include one or more constraints for the AI assistant to use to identify relevant portions of the communication records, extract those portions from the communication records, and then generate an analysis of those portions. For example, the user may wish to analyze certain communications within a particular time window, e.g., the past two weeks. To assist with this process, the AI assistant may provide the user with a graphical user interface (“GUI”) to select various options or they can enter their own free-form constraints to be used.

After the user has generated the query, the AI assistant accesses one or more identified communication channels, e.g., meeting transcripts, chat channels, or email inboxes, and retrieves communication records that satisfy the user's query, such as communication records that fall within the identified time period or includes particular individuals or identifies particular roles. For each different type of communication records accessed, the AI assistant then generates one or more prompts for an LLM to generate a summary of the communication records from that type of communication channel. For example, for meeting transcripts, the AI assistant may generate a prompt that requests a summary of the transcripts, a second prompt that specifies the length of the summary to be generated and the style to be used for the summary. In cases where the number of transcripts is larger than is supported by the LLM, the AI assistant may divide the transcript into smaller groups and generate prompts for those smaller groups to obtain multiple summaries, one for each group. The AI assistant may then provide the summaries to the LLM with one or more further prompts to generate a further summary based on the summaries. It then obtains summaries for each other type of communication channel specified by the user using a similar process.

After obtaining summaries for each of the different types of communication channels, the AI assistant may then generate a further prompt to summarize all of the various received summaries. The further prompt may provide additional constraints to the LLM, such as weights to apply to the different summaries, prioritizations of those different summaries, as well as reasons for those weights or prioritizations, or to provide context about the various summaries, such as those that represent spoken communication or written communications. The AI assistant then provides the one or more prompts to the LLM with the received summaries to receive a heterogeneous analysis of the communication records identified by the user's query. The heterogeneous analysis can then be provided to the user to apprise them of the various discussions had over the selected time period and communication channels.

Thus, by leveraging an AI assistant and a LLM, a user can effectively and efficiently analyze the communications between two or more people to obtain a concise summary of the entirety of the communications, but without burdening the user with reviewing the communications themselves for the relevant information.

This illustrative example is given to introduce the reader to the general subject matter discussed herein and the disclosure is not limited to this example. The following sections describe various additional non-limiting examples and examples of heterogeneous analysis of communication records using large language models.

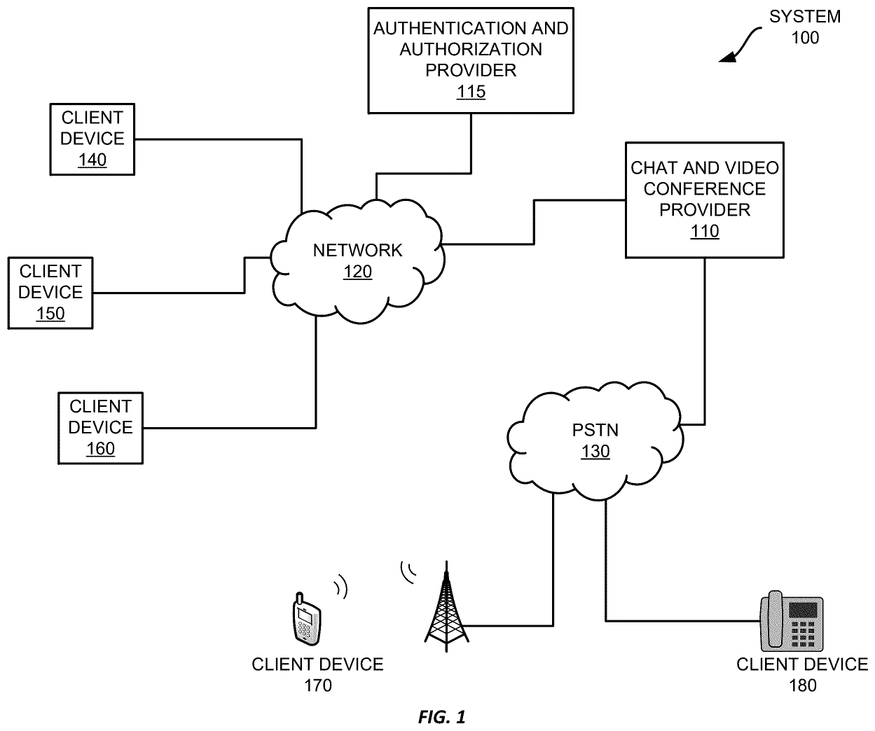

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

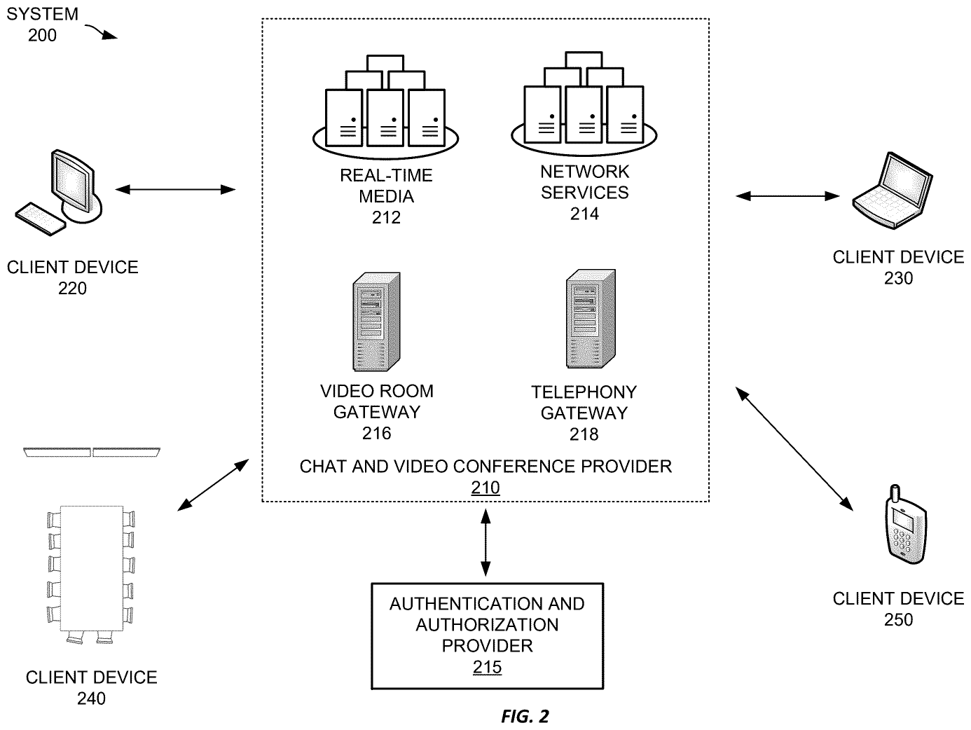

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real- time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220- 250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

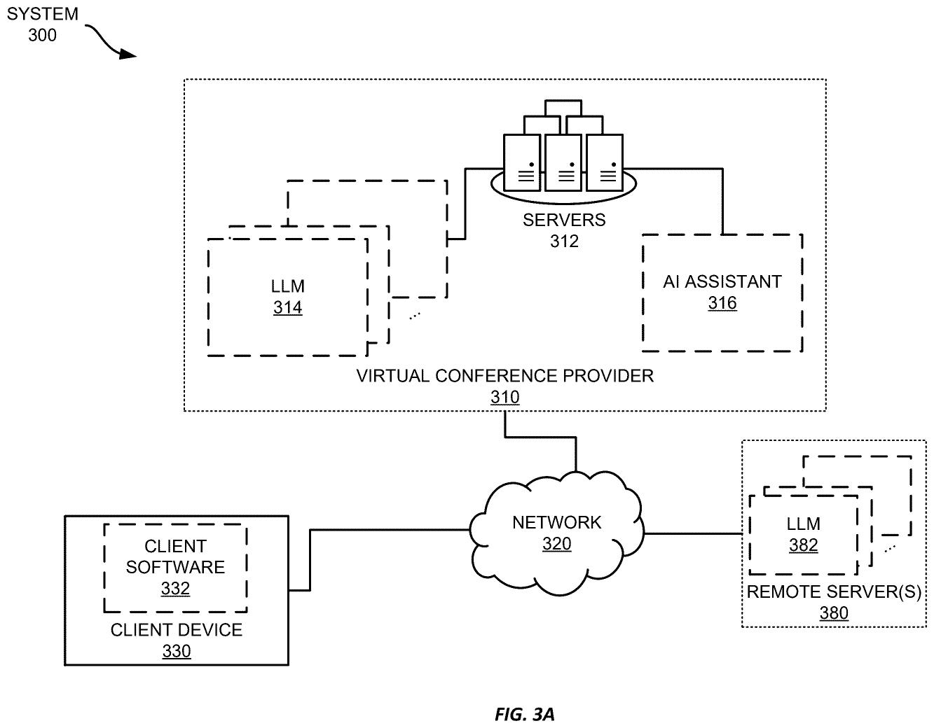

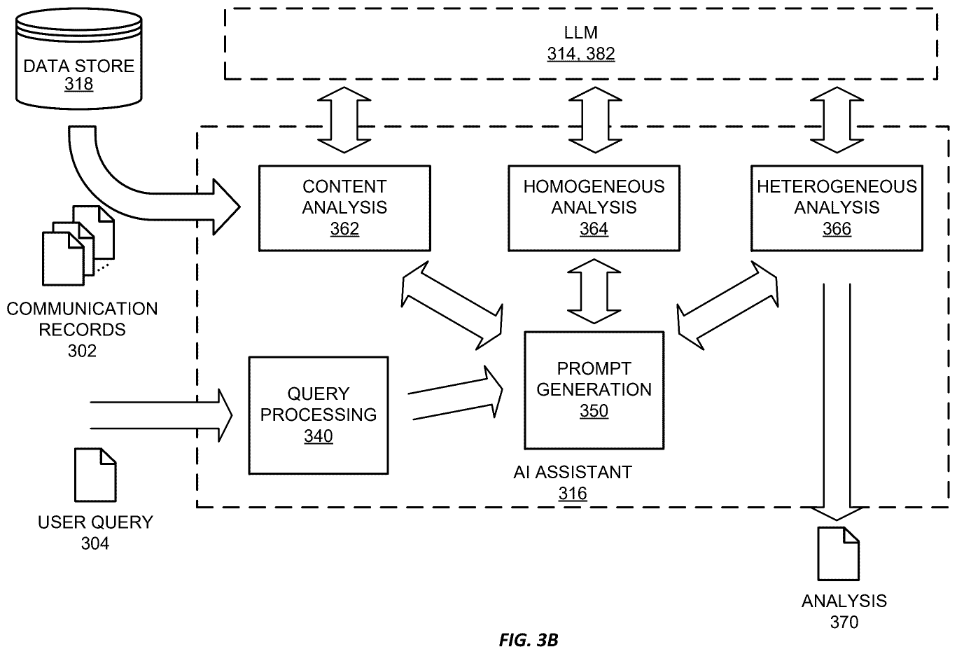

Referring now to FIGS. 3A-3B, FIG. 3A shows an example system 300 for heterogeneous analysis of communication records using LLMs. In this example, the system 300 includes a client device 330, a virtual conference provider 310, and one or more remote servers 380 that host one or more LLMs 382. In this example, the virtual conference provider 310 provides chat and virtual conferencing capabilities, such as discussed above with respect to FIGS. 1-2, but also provides one or more servers 312 that provide one or more LLMs 314 that may be used to service requests received from users via their respective client device, such as client device 330. In addition, the virtual conference provider 310 provides an AI assistant 316 to allow users to perform heterogeneous analysis of communication records using LLMs.

The LLM 314 may be a model that has been trained on a large corpus of data, such as information available from licensed, commercially usable, non-public datasets. For LLMs, the training data may be written materials, such as webpages, documents, emails, or blogs that may be relevant to generating written works.

Examples of LLMs include GPT models of different versions, autoregressive LLMs (e.g., Large Language Model Meta A (LLAMA)), transformer-based autoregressive LLMs (e.g., BigScience Large Open-science Open-access Multilingual Language Models (BLOOMs)), Zephyr, MISTRAL, causal decoder-only models (e.g., Falcon), or MosaicML Pretrained Transformer (MPT) models.

Client devices may execute client software 332 to join and participate in virtual conferences hosted by the virtual conference provider 310. During a virtual conference, the participants can exchange audio and video streams, as discussed above with respect to FIGS. 1-2, to interact with each other, discuss any topics of interest, and share content. The virtual conference provider 310 may then generate a transcript of the virtual conference, either in real-time or based on a recording of the virtual conference. In addition, the participants can continue any discussions outside of a virtual conference, such as by using chat functionality provided by the virtual conference provider or by collaborating on one or more documents or presentations. They may also email each other using email services provided by the virtual conference provider 310 or another third party. Thus, the participants may generate one or more communication records relevant to various topics of discussion. While the discussion below will be with respect to analysis of sets of communication records, it should be appreciated that it is equally applicable to analysis of a single communication record, such as a single virtual conference transcript.

To employ the AI assistant 316, a user of the client device 330 can interact with a GUI to provide a query that includes one or more constraints to the AI assistant 316 and identifies one or more types of communication records. The AI assistant then obtains communication records of the types specified by the user query and that satisfy the constraints provided by the user query. Based on the types of the communication records obtained, the AI assistant generates one or more instructions (or “prompts”) to an LLM 314, 382 to analyze one or more of the content records for a particular type. If multiple analyses are generated, the AI assistant 316 generates one or more instructions for the LLM 314, 382 to generate an analysis of the multiple analyses. The AI assistant 316 performs this same process for each set of communication records for each type of communication record to generate a set of type-specific analyses. After obtaining the analyses specific to the various types of communication records, the AI assistant 316 generates a further set of instructions to the LLM 314, 382 to provide a heterogenous analysis of all of the type-specific analyses according to any constraints provided in the user's query. The AI assistant 316 then outputs the heterogeneous analysis to the user.

Referring now to FIG. 3B, FIG. 3B shows an example AI assistant 316 for heterogeneous analysis of communication records using LLMs. In this example, the AI assistant 316 is executed by the virtual conference provider 310, but as discussed above, the client device 330 or a remote server 380 may execute the AI assistant 316. The AI assistant 316 includes query processing functionality 340, prompt generation functionality 350, content analysis functionality 362, homogeneous analysis functionality 364, and heterogeneous analysis functionality 366.

To perform heterogeneous analysis of one or more communication records 302, the AI assistant 316 receives a user query 304, which includes one or more constraints 306, and access to one or more identified communication records 302. In some cases, the communication records 302 may be received with the user query 304, a location of the communication records 302 may be received, or a combination. The user query 304 may include one or more constraints, which may be of several types. The user query 304 includes a constraint identifying the types of communication records 302 to be analyzed and may include additional constraints. For example, constraints may be time-based constraints, such as a time period from which communication records should be accessed, or person-based constraints, such as communication records involving communications with a particular person or persons. In some examples, formatting constraints may be provided as well. Formatting constraints may be related to the construction of the analysis output, such as a style (e.g., formal, casual, or bullet points), a desired length of the output, or a level of sophistication for the target audience of the output (e.g., lay person or subject matter expert).

After receiving the user query 304, the AI assistant 316 employs query processing functionality 340 to identify one or more constraints within the user query. In this example, the user query may be formatted with constraints explicitly identified. For example, a user may interact with a GUI window that includes various selections that can be used to tailor a query. Thus, each of the selections may be identified as a constraint and as a particular type of constraint and the query processing functionality 340 may extract the constraints from the user query 304. In some examples, a user query may be a free-form text field. In some such examples, the user query may be provided to a trained ML model, such as an LLM 314, 382, with an instruction to identify constraints within the query and the corresponding types of those constraints.

As discussed above, in response to the user query 304, one or more communication records 302 are provided to the AI assistant 316. The communication records 302 may be stored and maintained by the virtual conference provider 310, such as in data store 318, or another computing device, such as the client device 330 or a remote server 380. As discussed above, communication records 302 may include virtual conference transcripts, chat logs from one or more chat channels or chat messages exchanged during a virtual conference, emails, calendar information, documents, or other written record or communications.

In this example, the user query 304 includes a date range which is used to identify communication records 302 within the data store 318 that fall within the date range. In examples where additional constraints are provided, the initial set of communication records 302 that satisfy the date range may then be analyzed to determine whether the additional constraints are satisfied. For example, if the user identifies a specific individual (or individuals), the query processing 340 may analyze metadata associated with the communication records 302 to identify a subset of communication records 302 that include one or more of the identified individuals.

Similarly, other types of constraints may be employed in some examples, e.g., specific topics. In this example, the pre-processing functionality 318 employs natural language processing (“NLP”) to identify topics discussed within the communication record(s) 302, speakers or participants to the communications reflected in the communication record(s) 302, or roles, such as with respect to a particular organization, e.g., team lead, program lead, or executive.

Any suitable NLP functionality may be employed, such as latent semantic analysis or latent Dirichlet allocation to identify topics or other content- based information that may be extracted from the one or more communication records and classify portions of the communications records based on the identified topics or content-based information. Some examples may employ ML-based techniques, including support vector machines (“SVMs”) or neural networks, such as deep neural-networks (“NNs”) (e.g., recurrent NNs or convolutional NNs).

The AI assistant 316 may then select a subset of communication records 302 that satisfy the constraints provided by the user query 304. After selecting the communication records 302, the AI assistant 315 employs content analysis functionality 362, homogeneous analysis functionality 364, and heterogeneous analysis functionality 366 to generate a heterogeneous analysis 370 of the selected communication records.

To perform analysis of the communication records, the AI assistant 316 first employs content analysis functionality 362 to submit prompts to the LLM 314, 382 as well as one or more of the communication records 302. LLMs 314, 382 typically have limits on input size, thus, lengthy or large numbers of communication records 302 may exceed those limits. Thus, the content analysis functionality 362 submits subsets of the selected communication records 302 to the LLM 314, 382 along with a prompt based on the type of communication records being submitted. At this stage of the analysis, the content analysis 362 only submits communication records 302 of a single type with each prompt. Thus, if the set of selected communication records 302 includes meeting transcripts, chat logs, and emails, when providing a prompt to the LLM 314, 382, the content analysis functionality 362 will only obtain communication records 302 of a particular type, e.g., meeting transcripts, and obtain a prompt specific to the type of communication records 302 to be submitted.

The content analysis functionality 362 employs the prompt generation functionality 350 to obtain prompts for a particular type of communication record 302 to be submitted to the LLM 314, 382 for analysis. For example, the content analysis functionality 362 may request a prompt for meeting transcripts. In this example prompts for meeting transcripts may be pre-defined or be constructed according to a predefined template and based on one or more constraints from the user query 304. While certain constraints were discussed above, other constraints specific to the content summarization may include a focus for the analysis, such as a focus on decisions made, alignments with business objectives, action items, identified next steps, or open questions. Such constraints may be provided as free-form constraints within a GUI window or may be selected as options within such a window. Other types of constraints may include purpose-based constraints, such as specifying an in-depth analysis for any meetings missed by the user or a high-level analysis for any meetings attended by the user. Some examples may employ metadata, e.g., a calendar invite corresponding to a meeting, to ensure proper spellings of names of participants in the meeting or to identify particular communication records of interest. Using these constraints and the type of communication records to be analyzed, the prompt generation functionality 355 may generate a suitable prompt for the content analysis functionality 362.

For example, the prompt generation functionality 355 may generate a prompt according to a selected predefined template, such as according to the following format: “Summarize [communication records] about [topic]. The [communication records] involve spoken communications during a video conference. The summary should be [formatting constraint] long and use a [formatting constraint] level of complexity.” Such a template may be selected by the prompt generation functionality 350 when a topic constraint is provided by the user query 304. If no topic is provided, a different template that does not include the topic constraint, e.g., “Summarize [communication records]. The [communication records] involve spoken communications during a video conference. The summary should be [formatting constraint] long and use a [formatting constraint] level of complexity.” The content analysis functionality 362 may then provide the prompt and one or more communication records to the LLM 314, 382 to analyze. If the content analysis functionality 362 is not able to submit all communication records 302 of a particular type to the LLM 314, 382 with a single prompt, e.g., because it exceeds the input limit for the LLM 314, 382, it may then repeat the process as many times as needed for the remaining communication records of that type. It may then repeat the process for each remaining type of communication records 302 specified in the user query 304.

As discussed above, different communication record types may employ different prompts. The example provided above may be specific to a video conference transcript, but other type-specific prompts may be employed. For example, the prompt generation functionality 350 may employ a template similar to the following for emails: “Summarize [communication records] about [topic]. The communication records involve email communications. The analysis should be performed on the email bodies and subject lines, but should exclude signature blocks. The summary should be [formatting constraint] long and use a [formatting constraint] level of complexity.” An example template for chat logs may be similar: “Summarize [communication records] about [topic]. The communication records involve chat messages. The analysis should be performed on the chat messages, but should exclude emojis, reactions, and text-based emotional responses, such as ‘lol.’ The summary should be [formatting constraint] long and use a [formatting constraint] level of complexity.”

As discussed above, the content analysis functionality 364 may need to submit multiple prompts with different communication records 362 based on limits imposed by the LLM 314, 382. Other approaches to reduce the input size may be to omit or delete portions of the communication records, such as by removing portions of the beginning of the communication record, which is likely to include introductions or small talk, or the end of the communication record, which is likely to include small-talk or goodbyes that are of little importance to the analysis. The content analysis functionality 364 may also break one or more communication records into multiple segments that are within the input size limits of the LLM 314, 382. Still other suitable approaches to reduce the size of one or more communication records may be employed.

After the AI assistant 316 has used the content analysis functionality 362 to generate analyses of the various types of communication records, it then employs the homogeneous analysis functionality 364 to prepare a single analysis for each type of communication record. As discussed above, the LLM 314, 382 may have input limits, which may necessitate the content analysis functionality 362 to submit multiple prompts per type of communication record. Thus, the AI assistant 316 may receive multiple different analyses for each type of communication record. The homogeneous analysis functionality 364 employs the prompt generation functionality 350 to generate a prompt to generate analysis of all analyses for a particular type of communication record 302. For example, if multiple analyses were generated for meeting transcripts, the homogeneous analysis functionality 316 would obtain a prompt from the prompt generation functionality 350 to submit the multiple analyses to the LLM 314, 382 to obtain a homogeneous analysis for the meeting transcripts within the communication records 302.

In this example, the prompt generation analysis 350 may employ a different template for the homogeneous analysis functionality 364 than for the content analysis functionality 362. For example, the prompt generation functionality 350 may use a template similar to: “Summarize these analyses. The analyses were generated from meeting transcripts from multiple video conferences over a [time period] period. The summary should be [formatting constraint] long and use a [formatting constraint] level of complexity.” Similar templates may be employed for other types of communication records. For example, a suitable template for chat messages may be: “Summarize these analyses. The analyses were generated from chat logs over a [time period] period. The summary should be [formatting constraint] long and use a [formatting constraint] level of complexity.”

The homogeneous analysis functionality 364 thus generates a single homogeneous analysis for each type of communication record. However, if the homogeneous analysis functionality 364 cannot submit all analyses with a single prompt, it may submit multiple prompts, similarly as discussed above with respect to the content analysis functionality 362. However, ultimately, the homogeneous analysis functionality will generate a single homogeneous analysis. Thus, if it must submit the analyses from the content analysis functionality using multiple prompts, it then obtains the outputs of those multiple prompts and submits them collectively with another prompt to generate a single homogeneous analysis. If a very large number of analyses were generated, it may repeat this process until a single homogeneous analysis has been generated.

After homogeneous analyses have been generated for each type of communication record 302 specified in the user query 304, the heterogeneous analysis functionality 366 employs the prompt generation functionality to generate a prompt to submit the collection of homogeneous analyses to the LLM 314, 382 to obtain a heterogeneous analysis. The prompt generation functionality 350 may then generate a prompt suitable for heterogeneous analysis of the types of communication records. The prompt may provide instructions regarding how to weight different types of communication records, how to prioritize different types of communication records, or provide context about the different types of communication records. For example, the prompt generation functionality 350 may receive a request for a prompt from the heterogeneous analysis functionality that identifies the types of communication records represented by the homogeneous analyses. The prompt generation functionality 350 may then select one or more templates to use to generate a prompt.

For example, the prompt generation functionality 350 may generate a prompt similar to the following: “Summarize these analyses, which include meeting analysis, chat log analysis, and email analysis. The meeting analysis represents spoken content while the chat log analysis and email analysis represent written communication. Apply greater weight to any spoken content over written communication. Prioritize the analyses in order of meeting analysis, email analysis, chat log analysis.” In this example, the generated prompt specifies weights for different types of communication records 302 and a priority for the different types of communication records 302. In some examples a user may provide one or more constraints indicating weights or priorities. In some examples, the AI assistant 316 may be pre-configured to more heavily weight certain types of communication records or may have a pre-defined priority scheme for different types of communication records. In this example, the prompt generation functionality 350 has merged three different template prompts based on the types of communication records 302 and constraints provided by the user query 304. The first template identifies the types of communication records 302 represented: “Summarize these analyses, which include meeting analysis, chat log analysis, and email analysis.” The second template identifies the weights to be used: “Apply greater weight to any spoken content over written communication.” And the third template provides priorities to be used: “Prioritize the analyses in order of meeting analysis, email analysis, chat log analysis.” Thus, based on the various constraints provided by the user query 304, the prompt generation functionality 350 may select suitable templates that may be combined to generate a prompt for heterogeneous analysis.

The heterogeneous analysis functionality 366 then submits the prompt and the homogeneous analyses to the LLM 314, 382, which generates a heterogeneous analysis 370 that is provided to the user.

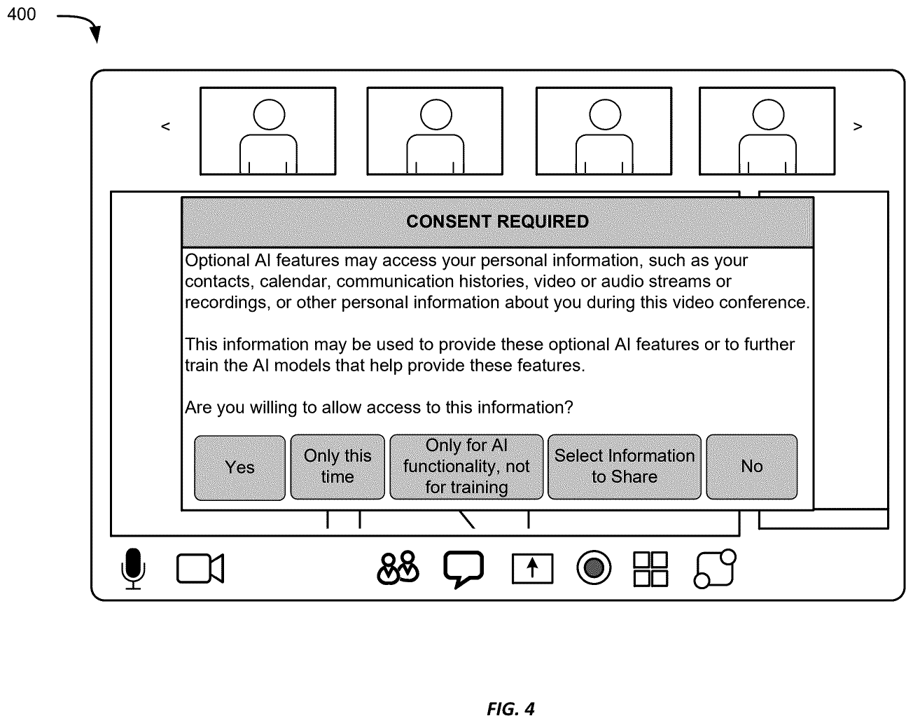

Referring to FIG. 4, FIG. 4 shows a GUI 400 presenting a consent option to employ certain AI-assisted features. In some examples according to the present disclosure, a user may select an option to use one or more optional AI features available from the virtual conference provider, such as the heterogeneous analysis of communication records as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 4, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

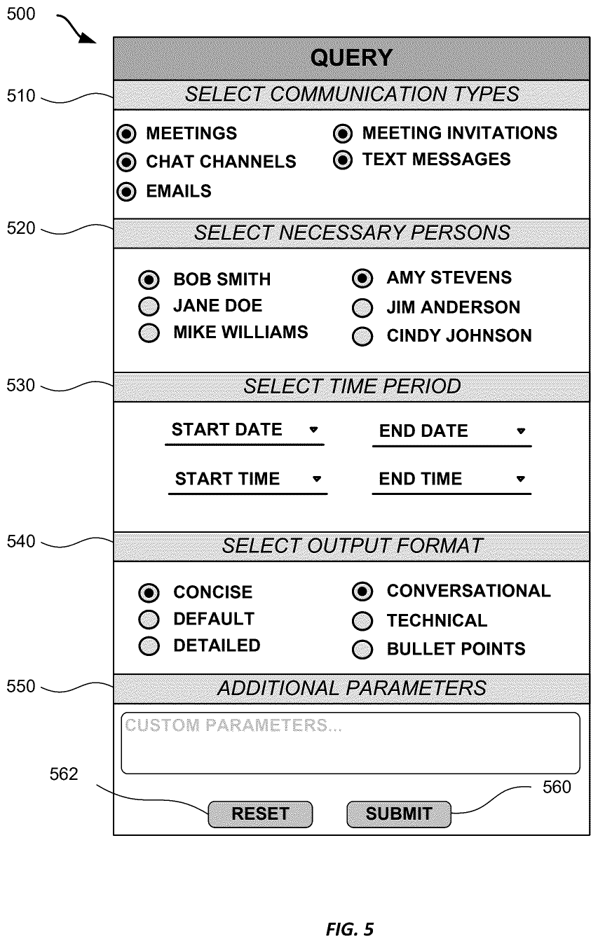

Referring to FIG. 5, FIG. 5 shows an example view of a GUI window 500 that provides selectable query options for heterogeneous analysis of communication records using LLMs. In this example, the user is presented with a variety of options that may be used to generate a heterogeneous analysis of communication records. The user has selected various types of communication records by selecting radio buttons corresponding to the supported types of communication records 510. In this example, the system provides analysis of meeting transcripts, logs from chat channels, emails, calendar invitations, and text or short message service (“SMS”) messages. However, any other type of communication records may be supported, including presentation slide decks, attachments to calendar invites or emails, and collaborative documents shared amongst multiple users.

Based on the selected communications, the GUI window 500 presents the user with additional options. In this example, the AI assistant 316 provides information about other persons 520 that may be of interest to the user. In this example, the AI assistant has identified one or more people that are frequently involved with communication records selected by the user. For example, the user may frequently attend meetings with Bob Smith and Jane Doe. The user may also email regularly with all of the identified persons. Other options, such as roles, e.g., a supervisor or one or more direct reports or one or more executives, may also be displayed in some examples.

The user is also provided with an option to provide a time period to use to filter communication records for analysis. In this example, the user can select a start date or time and an end date or time. Some examples may provide pre-defined options, such as “Past two weeks” or a specific month or quarter.

In addition, the GUI window 500 allows the user to select an output format for the heterogeneous analysis. In this example, the user has selected a concise output format that employs a conversational tone.

Finally, the GUI window 500 provides an option for the user to provide any additional parameters or instructions to the LLM 314, 382 to accompany the query 304. The instructions may specify any suitable constraints 306 or other requirements that the LLM 314, 382 should employ when performing the heterogeneous analysis. The user may then select the “submit” button 570 to submit the query 304 to the AI assistant 316 for heterogeneous analysis. The user may instead select the reset button 572 to reset all of the selections that may have been made.

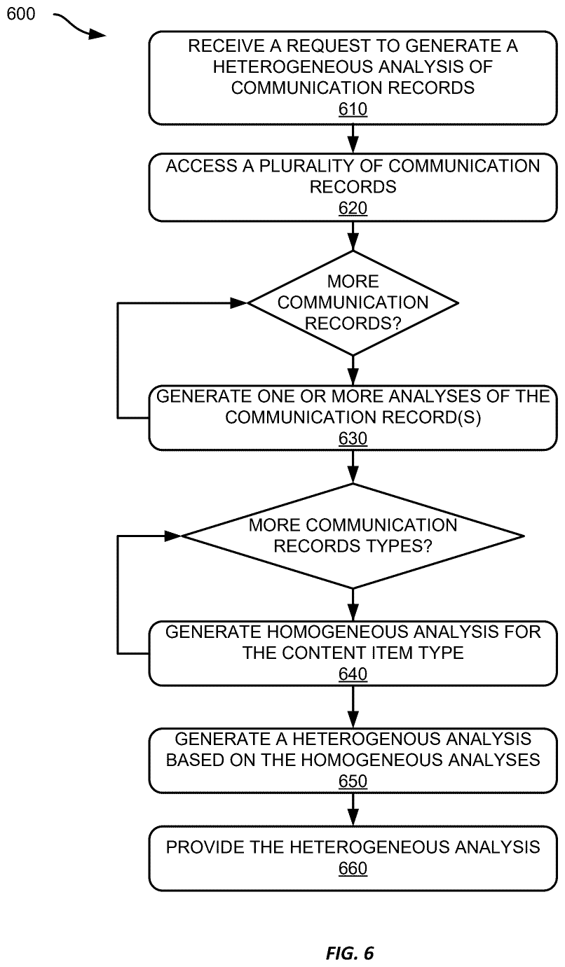

Referring now to FIG. 6, FIG. 6 shows an example method 600 for heterogeneous analysis of communication records using LLMs. The method 600 will be described with respect to the system 300 shown in FIGS. 3A-3B and the GUI window 500 shown in FIG. 5; however, it should be appreciated than any suitable system or GUI window according to this disclosure may be employed for example methods according to this disclosure. Moreover, while the discussion above and herein is in the context of a virtual conference provider, it should be appreciated that any service provider may be employed, or the functionality may be performed by a user's own client device.

At block 610, the AI assistant 316 receives a request to generate a heterogeneous analysis 370 of communication records 302. In this example, the user interacts with the GUI window 500 to establish constraints for a user query 304, which may be related to the types of communication records 510, relevant persons 520 or roles, or a time period 530, or on the output 540, based on one or more format constraints. In this example, the user may select one or more pre-populated constraint options or may enter their own constraints via the free-form additional parameter option 550. However, in some examples, the user may compose a user query without such options, such as by entering all desired constraints within a text input window, such as the additional parameters 550 text input window.

At block 620, the AI assistant 316 accesses a plurality of communication records 302 generally as described above with respect to FIG. 3B. In this example, the AI assistant 316 receives the communication records from a user as one or more files containing the communications between the individuals. However, in some examples, the AI assistant 316 may receive a uniform resource identifier (“URI”), such as a uniform resource locator (“URL”), that identifies a name and location of a communication record. Such communication records may be located on a client computer 330, at a virtual conference provider 310, or at one or more remote servers or other computing device(s). The AI assistant 316 may then retrieve or otherwise access the communication record(s) using such information. In some examples, the communication records may be stored at a client device 330 or at a remote server, such as in the case of one or more email messages stored in an inbox or calendar information stored in a calendar. Thus, the AI assistant 316 may be provided with information to access the relevant inbox(s) or calendar(s), such as an email address and a password, or other access credentials.

At block 630, the AI assistant 316 generates one or more analyses of communication records of one type, such as one or more email messages, generally as discussed above with respect to the discussion of the content analysis functionality 362 in FIG. 3B. As discussed above, the AI assistant 316 employs the content analysis functionality 362 and the prompt generation functionality 350 to generate a prompt to analyze one or more communication records using an LLM 314, 382. In this example, the AI assistant 316 generates a prompt using prompt generation functionality 362 based on the type of communication records 302 to be analyzed and provides one or more of the communication records 302 of that type with the prompt to the LLM 314, 382. As discussed above, an LLM 314, 382 may have a limit on input size, thus the AI assistant 316 may only be able to provide a part of one communication record with the prompt, or it may be able to provide multiple communication records with the prompt. In response, the LLM 314, 382 generates an analysis of the communication records based on the prompt. The AI assistant 316 then determines if any communication records of that type. Once all of the communication records for that type have been used, the AI assistant 316 then performs the same process for the remaining communication records of other types.

At block 640, the AI assistant 316 generates a homogeneous analysis of the one or more analyses of communication records of one type, generally as discussed above with respect to the discussion of the homogeneous analysis functionality 364 and the prompt generation functionality 350 in FIG. 3B. For example, as discussed above, the homogeneous analysis functionality 364 employs the prompt generation functionality 350 to generate a prompt to submit to the LLM 314, 382 with the analyses for a particular type of communication record. Because the LLM 314, 382 may have an input size limit, the homogeneous analysis functionality 364 may submit multiple prompts to the LLM 314, 382 to generate multiple homogeneous analyses. The homogeneous analysis functionality 364 may then repeat the process to analyze the multiple homogeneous analyses until only a single homogeneous analysis has been generated. In some examples, the size of the single homogeneous analysis may be compared to a threshold, and if the threshold is satisfied, the homogeneous analysis functionality 364 may generate a prompt to generate a more concise homogeneous analysis: “Generate a more concise version of the following input.” Once a homogeneous analysis of one type of communication record has been generated, the AI assistant continues to generate additional homogeneous analyses of the other selected types of communication records until a homogeneous analysis of each selected type of communication record has been generated.

At block 650, the AI assistant 316 generates a heterogeneous analysis of the homogeneous analyses of the types of communication records generally as discussed above with respect to the heterogeneous analysis functionality 366 discussed above FIG. 3B. In this example, the heterogeneous analysis functionality 366 employs the prompt generation functionality 350 to generate a prompt to the LLM 314, 382 to generate a heterogeneous analysis 370 of the homogeneous analyses generated by the homogeneous analysis functionality 364 at block 640. Because the LLM 314, 382 may be limited in input size, as discussed above, the heterogeneous analysis functionality 366 may provide multiple inputs to the LLM 314, 382 to generate multiple heterogeneous analyses, which may in turn be provided to the LLM 314, 382 with a prompt generated by the prompt generation functionality 350 to generate a single heterogeneous analysis 370.

At block 660, the heterogeneous analysis 370 is provided in response to the request. In this example, the heterogeneous analysis 370 is displayed to the user in a GUI, while in some examples, the heterogeneous analysis 370 may be provided via an email or a chat message or any other suitable mechanism.

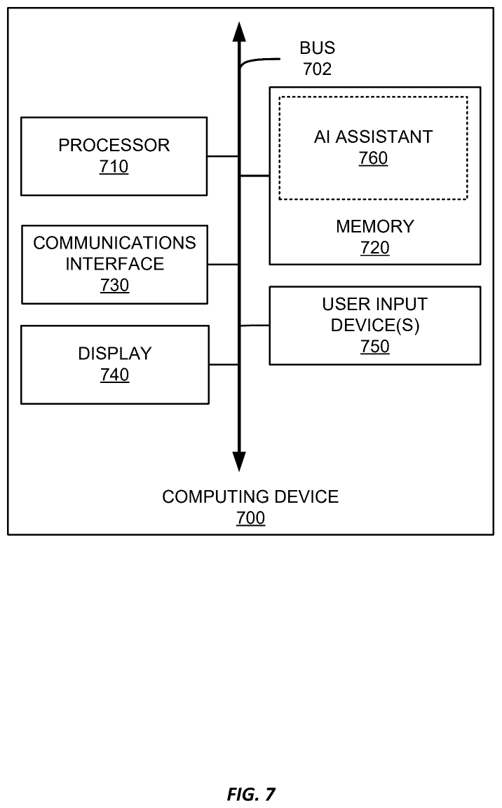

Referring now to FIG. 7, FIG. 7 shows an example computing device 700 suitable for use in example systems or methods for heterogeneous analysis of communication records using LLMs according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for heterogeneous analysis of communication records using LLMs according to different examples, such as part or all of the example method 600 described above with respect to FIG. 6. Suitable example computing devices 700, such as user client devices, may also include one or more user input devices 750, such as a keyboard, mouse, touchscreen, microphone, etc., to accept user input. The computing device 700 also includes a display 740 to provide visual output to a user. In addition, the computing device 700 includes an AI assistant 760, such as discussed above with respect to FIGS. 3A-3B.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a request to generate an analysis of communication records, the communication records associated with a plurality of types of communication records;
accessing a plurality of communication records associated with the request, each communication record of the plurality of communication records corresponding to one type of the plurality of types of communication records;
for the communication records of a respective type of communication records, generating, using a trained large language model (“LLM”), one or more analyses of the respective communication records;
for each type of communication record, generating, using the trained LLM, a homogeneous analysis of the one or more analyses of the respective communication records corresponding to the respective type of communication records;
generating, using the trained LLM, a heterogeneous analysis of the homogeneous analyses of the types of communication records; and
providing the heterogeneous analysis in response to the request.

2. The method of claim 1, wherein the plurality of types of communication records comprises meeting transcripts, chat logs, emails, meeting or calendar invitations, text messages, or documents.

3. The method of claim 1, further comprising, for each communication record of a respective type of communication records, generating an LLM prompt based on the respective type of communication records.

4. The method of claim 3, wherein generating the LLM prompt is based on metadata corresponding to the respective communication records corresponding to the respective type of communication records.

5. The method of claim 1, further comprising, for each type of communication records, responsive to determining that a size of the respective homogeneous analysis satisfies a threshold, using the LLM to re-analyze the respective homogeneous analysis, and wherein generating the homogeneous analysis employs the respective re-analysis of the homogeneous analysis.

6. The method of claim 1, wherein generating the heterogeneous analysis comprises providing one or more instructions to the LLM indicating information about the one or more types of communication records.

7. The method of claim 1, wherein generating the heterogeneous analysis comprises providing one or more instructions to the LLM indicating a weight for one or more types of communication records.

8. The method of claim 1, wherein generating the heterogeneous analysis comprises providing one or more instructions to the LLM indicating a prioritization of the one or more types of communication records.

9. A system comprising:
a non-transitory computer-readable medium; and
one or more processors communicatively connected to the non-transitory computer-readable medium, the one or more processors configured to execute processor-executable instructions stored in the non-transitory computer-readable medium to cause the one or more processors to:
receive a request to generate an analysis of communication records, the communication records associated with a plurality of types of communication records;
access a plurality of communication records associated with the request, each communication record of the plurality of communication records corresponding to one type of the plurality of types of communication records;
for the communication records of a respective type of communication records, generate, using a trained large language model (“LLM”), one or more analyses of the respective communication records;
for each type of communication record, generate, using the trained LLM, a homogeneous analysis of the one or more analyses of the respective communication records corresponding to the respective type of communication records;
generate, using the trained LLM, a heterogeneous analysis of the homogeneous analyses of the types of communication records; and
provide the heterogeneous analysis in response to the request.

10. The system of claim 9, wherein the plurality of types of communication records comprises meeting transcripts, chat logs, emails, meeting or calendar invitations, text messages, or documents.

11. The system of claim 9, wherein the one or more processors are configured to execute further processor-executable instructions stored in the non-transitory computer-readable medium to, for each communication record of a respective type of communication records, generate an LLM prompt based on the respective type of communication records.

12. The system of claim 11, wherein generating the LLM prompt is based on metadata corresponding to the respective communication records corresponding to the respective type of communication records.

13. The system of claim 9, wherein the one or more processors are configured to execute further processor-executable instructions stored in the non-transitory computer-readable medium to, for each type of communication records, responsive to determining that a size of the respective homogeneous analysis satisfies a threshold, use the LLM to re-analyze the respective homogeneous analysis, and wherein generating the homogeneous analysis employs the respective re-analysis of the homogeneous analysis.

14. The system of claim 9, wherein the one or more processors are configured to execute further processor-executable instructions stored in the non-transitory computer-readable medium to provide one or more instructions to the LLM indicating information about the one or more types of communication records.

15. The system of claim 9, wherein the one or more processors are configured to execute further processor-executable instructions stored in the non-transitory computer-readable medium to provide one or more instructions to the LLM indicating a weight for one or more types of communication records.

16. The system of claim 9, wherein the one or more processors are configured to execute further processor-executable instructions stored in the non-transitory computer-readable medium to provide one or more instructions to the LLM indicating a prioritization of the one or more types of communication records.

17. A non-transitory computer-readable medium comprising processor-executable instructions configured to cause one or more processors to:
receive a request to generate an analysis of communication records, the communication records associated with a plurality of types of communication records;
access a plurality of communication records associated with the request, each communication record of the plurality of communication records corresponding to one type of the plurality of types of communication records;
for the communication records of a respective type of communication records, generate, using a trained large language model (“LLM”), one or more analyses of the respective communication records;
for each type of communication record, generate, using the trained LLM, a homogeneous analysis of the one or more analyses of the respective communication records corresponding to the respective type of communication records;
generate, using the trained LLM, a heterogeneous analysis of the homogeneous analyses of the types of communication records; and
provide the heterogeneous analysis in response to the request.

18. The non-transitory computer-readable medium of claim 17, further comprising processor-executable instructions configured to cause the one or more processors to, for each communication record of a respective type of communication records, generate an LLM prompt based on the respective type of communication records.

19. The non-transitory computer-readable medium of claim 17, further comprising processor-executable instructions configured to cause the one or more processors to provide one or more instructions to the LLM indicating a weight for one or more types of communication records.

20. The non-transitory computer-readable medium of claim 17, further comprising processor-executable instructions configured to cause the one or more processors to provide one or more instructions to the LLM indicating a prioritization of the one or more types of communication records.
